(19) United States
(12) Patent Application Publication
(10) Pub. No.: US 2007/0229722 A1
(43) Pub. Date: Oct. 4, 2007

(54) Pixel structure and liquid crystal display panel thereof

(76) Inventor: Wen-Hsiung Liu, Neipu Township (TW)

Correspondence Address: J.C. Patents, Inc., Suite 250, 4 Venture, Irvine, CA, 92618, US

(21) Appl. No.: 11/397,659

(22) Filed: Apr. 3, 2006

(51) Int. Cl. G02F 1/136

(52) U.S. Cl. 349/43

(57) ABSTRACT

A pixel structure comprising a substrate, a first metal layer, a first dielectric layer, a semiconductor layer, a second metal layer and a pixel electrode is provided. The first metal layer, disposed on the substrate, includes a gate and a scan line. The first dielectric layer covers the first metal layer. The semiconductor layer is disposed on the first dielectric layer above the gate. The second metal layer includes a source, a drain and a data line connected with the source. The pixel electrode is electrically connected with the drain. Wherein, the drain has a main body and an extension portion projecting out of the scan line. The main body has a first length (L1). The interface of the extension portion and the scan line is a second length (L2). The L1/L2 is predetermined such that the Cgd of the pixel structure is fixed.

### BACKGROUND OF THE INVENTION

1. Field of Invention

The present invention relates to a pixel structure and a display panel, and more particularly to a pixel structure of a fixed gate-drain capacitance (Cgd) and a Liquid Crystal Display (LCD) panel using the same.

2. Description of Related Art

With the rapid development of video technology, the Flat Display Panel (FDP) has become an important interface for people to receive video information. Wherein, since the LCDs have superior display quality and mature fabrication technology, most of the display screens of mobile phones, digital cameras and notebook computers all use the LCD panel.

Generally speaking, the fabricating process of the thin film transistor (TFT) array substrate in the LCD panel usually includes a plurality of lithographing and etching steps. The pattern on the mask is transferred to a photoresist layer formed on the substrate through an exposure process, and the photoresist layer is patterned through a developing procedure. Next, the patterned photoresist layer is used as an etching mask to etch the film layer under the photoresist layer to further form a TFT gate, a semiconductor layer, a source, a drain, a pixel electrode and a protection layer and other components.

FIG. 1 is a schematic diagram of a conventional pixel structure. Referring to FIG. 1, the pixel structure 100 is suitable to be driven by a scan line 110 and a data line 120, and the pixel structure 100 includes a TFT 130 and a pixel electrode 140. The TFT 130 is electrically connected to the pixel electrode 140 through a contact opening 150. Wherein, the TFT 130 includes a gate 130a, a semiconductor layer 130b, a source 130c, and a drain 130d. And the gate 130a and the scan line 110 are the first metal layer. The source 130c, the drain 130d and the data line 120 are the second metal layer. Note that there is a dielectric layer (not shown) between the gate 130a (the first metal layer) and the source 130c and the drain 130d (the second metal layer), so that the gate-source capacitance (called Cgs hereinafter) and a gate-drain capacitance (called Cgd hereinafter) are respectively generated between the gate 130a and the source 130c and the drain 130d.

Base on the above descriptions, when using the lithographic etching method to fabricate the above first metal layer and second metal layer components, if an exposure shifting occurs, then the Cgs and Cgd of the TFT 130 will change accordingly.

FIG. 2A is a schematic diagram of the pixel structure without the exposure shifting and a pixel voltage thereof. FIG. 2B is a schematic diagram of the pixel structure with the exposure shifting and the pixel voltage thereof. Referring to FIG. 2A, in the pixel structure 100A, the source 130c is above the gate 130a, and the drain 130d is partially above the gate 130a. Please refer to FIG. 2B, where a case with the exposure shifting is shown. That is, the source 130c′, drain 130d′ shifted downwards relative to the gate 130a′, therefore the overlapped area between the source 130c′ and the gate 130a′ of the pixel structure 100B is reduced, and the overlapped area between the drain 130d′ and the gate 130a′ is increased accordingly.

Bases on the above description, in FIG. 2B, since the overlapped area between the drain 130d′ and the gate 130a′ is increased, the Cgd of the pixel structure 100B will be greater than the Cgd of the pixel structure 10A. And according to the following formula (I), the greater Cgd will reduce the feed through voltage (called ΔVp hereinafter).

$$\begin{matrix}Δ {V}_{p} = \frac{{C}_{gd}}{{C}_{gd} + {C}_{si} + {C}_{LC}} Δ {V}_{g} & ( 1 ) \\ & \end{matrix}$$

It can be seen that even though the same gate signal and the source signal are input, due to the Cgd change caused by the above exposure shifting, the feed through voltage ΔV_{A}, ΔV_{B} generated in FIG. 2A and FIG. 2B may be different. Therefore, the pixel structure 100B's brightness B (pixel voltage) will be lower than the pixel structure 100A's brightness A. As a result, the pixels on the LCD panel (not shown) will produce different display brightness, and as a consequence, the display quality of the LCD panel is reduced.

### SUMMARY OF THE INVENTION

In light of the above, an object of the present invention is to provide a pixel structure to solve the Cgd change problem due to the occurrence of the exposure shifting.

Another object of the present invention is to provide a LCD panel using the above pixel structure to improve the display quality of the LCD panels.

For the above or other objects, the present invention provides a pixel structure including a substrate, a first metal layer, a first dielectric layer, a semiconductor layer, a second metal layer and a pixel electrode. The first metal layer is disposed on the substrate, and the first metal layer includes the gate and a scan line which is electrically connected to the gate. The first dielectric layer is disposed on the substrate and covering the first metal layer. The semiconductor layer is disposed on the first dielectric layer over the gate. The second metal layer includes a source, a drain and a data line. The source and drain are partially disposed on the semiconductor layer. The data line and the source are electrically connected. The pixel electrode and the drain are electrically connected. Wherein, the drain includes a main body which is partially on the semiconductor layer and an extension portion projected out of the scan line from the main body. The main body has a first length, the interface of the extension portion and the scan line is the second length, and the first length/the second length is a predetermined ratio.

In an embodiment of the present invention, the above predetermined ratio is (∈_{SE}t_{GI}+∈_{GI}t_{SE})/(∈_{GI}t_{SE}), wherein ∈_{SE} is the dielectric constant of the semiconductor layer, t_{GI} is the thickness of the first dielectric layer, ε_{GI} is the dielectric constant of the first dielectric layer, and t_{SE} is the thickness of the semiconductor layer.

In an embodiment of the present invention, the above predetermined ratio is 1/4.

In an embodiment of the present invention, the above gate is the scan line itself.

In an embodiment of the present invention, the above semiconductor layer includes a channel layer and an ohmic contact layer. The channel layer is disposed on the first dielectric layer over the gate. The ohmic contact layer is disposed on the channel layer.

In an embodiment of the present invention, the above pixel structure further includes a second dielectric layer disposed on the substrate and covering the second metal layer.

In an embodiment of the present invention, the above second dielectric layer has an opening exposing a portion of the drain, so that the pixel electrode on the second dielectric layer is electrically connected to the drain through the opening.

For the above or other objects, the present invention further provides a LCD panel including a TFT array substrate, a color filter substrate and a liquid crystal layer. The TFT array substrate has a plurality of the pixel structures, wherein each pixel structure includes the substrate, the first metal layer, the first dielectric layer, the semiconductor layer, the second metal layer and the pixel electrode. The first metal layer is disposed on the substrate, and the first metal layer includes the gate and the scan line which is electrically connected to the gate. The first dielectric layer is disposed on the substrate and covering the first metal layer. The semiconductor layer is disposed on the first dielectric layer above the gate. The second metal layer includes the source, the drain and the data line. The source and the drain are partially disposed on the semiconductor layer. The data line is electrically connected to the source. The pixel electrode is electrically connected to the drain. The color filter substrate is disposed on the opposite side the TFT array substrate. The liquid crystal layer is disposed between the TFT array substrate and the color filter substrate. Wherein, the drain has an main body partially disposed on the semiconductor layer and an extension portion projected out of the scan line from the main body. The main body has a first length, and the interface of the extension portion and the scan line is the second length, and the first length/the second length is a predetermined ratio.

In an embodiment of the present invention, the above predetermined ratio is (∈_{SE}t_{GI}+∈_{GI}t_{SE})/(∈_{GI}t_{SE}), wherein ∈_{SE} is the dielectric constant of the semiconductor layer, t_{GI} is the thickness of the first dielectric layer, ∈_{GI} is the dielectric constant of the first dielectric layer, and t_{SE} is the thickness of the semiconductor layer.

In an embodiment of the present invention, the above predetermined ratio is 1/4.

In an embodiment of the present invention, the above gate is the scan line itself.

In an embodiment of the present invention, the above semiconductor layer includes a channel layer and an ohmic contact layer. The channel layer is disposed on the first dielectric layer over the gate. The ohmic contact layer is disposed on the channel layer.

In an embodiment of the present invention, the above pixel structure further includes a second dielectric layer disposed on the substrate and covering the second metal layer.

In an embodiment of the present invention, the above second dielectric layer has an opening exposing a portion of the drain, so that the pixel electrode on the second dielectric layer is electrically connected to the drain through the opening.

For the pixel structure of the present invention, since the drain has an main body partially disposed on the semiconductor layer and an extension portion projected out of the scan line from the main body, and the main body has the first length, and the interface of the extension portion and the scan line is the second length, moreover, the first length/(divided by) the second length is a predetermined ratio, even though an exposure shifting occurs during the fabricating process of the pixel structure, the Cgd does not change. Therefore, each pixel structure can produce the same brightness, and the LCD panel using such pixel structure also has better display quality.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic diagram of a conventional pixel structure.

FIG. 2A is a schematic diagram of the pixel structure A without the exposure shifting and a pixel voltage thereof.

FIG. 2B is a schematic diagram of the pixel structure B with the exposure shifting and the pixel voltage thereof.

FIG. 3 is a schematic diagram of a pixel structure in an embodiment of the present invention.

FIG. 4 is a schematic detailed view of the pixel structure in FIG. 3.

FIG. 4A is a schematic section view along line A-A′ in FIG. 4.

FIG. 5 is a schematic diagram when the exposure shifting occurs on the pixel structure in FIG. 4.

FIG. 6 is a schematic diagram of a LCD panel of an embodiment of the present invention.

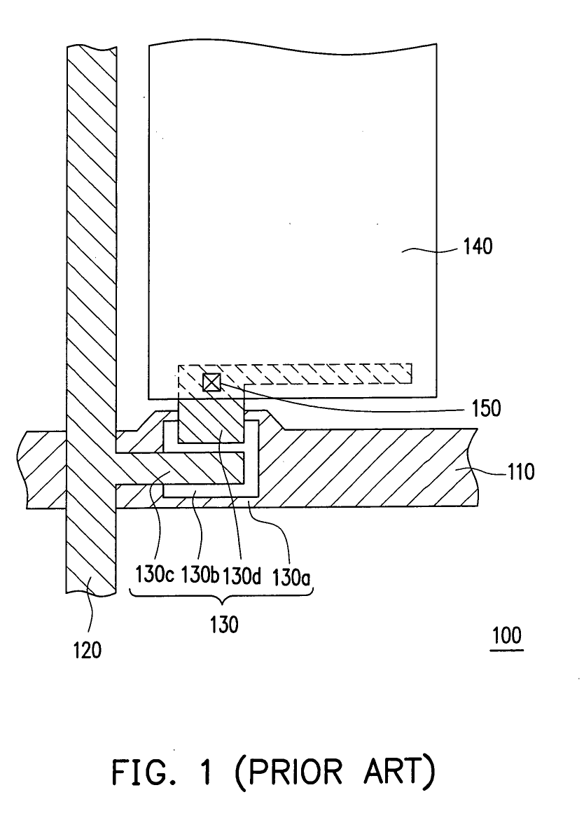

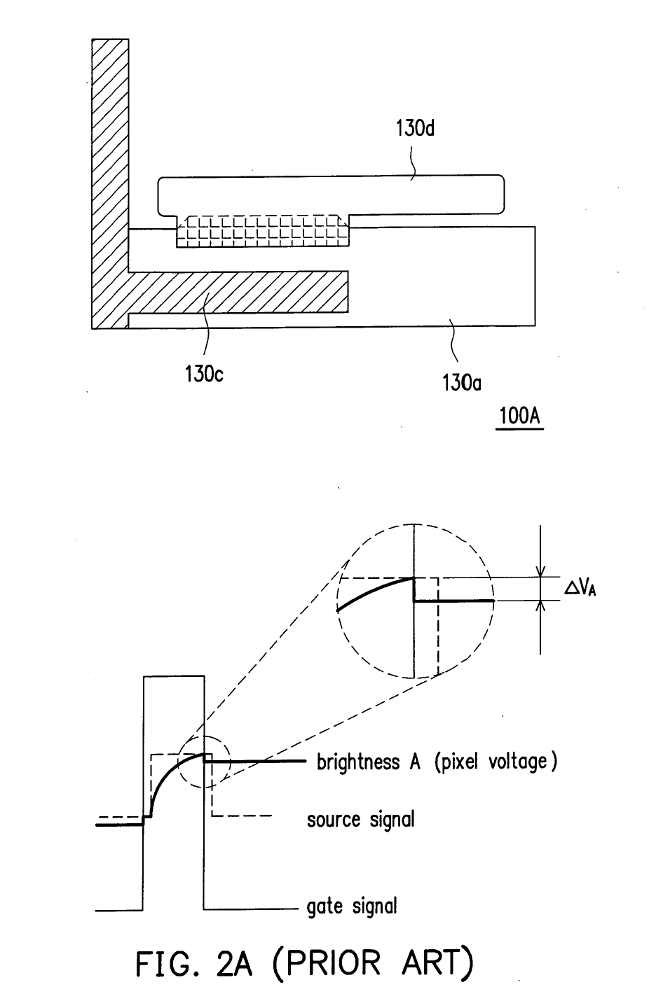

### DESCRIPTION OF EMBODIMENTS

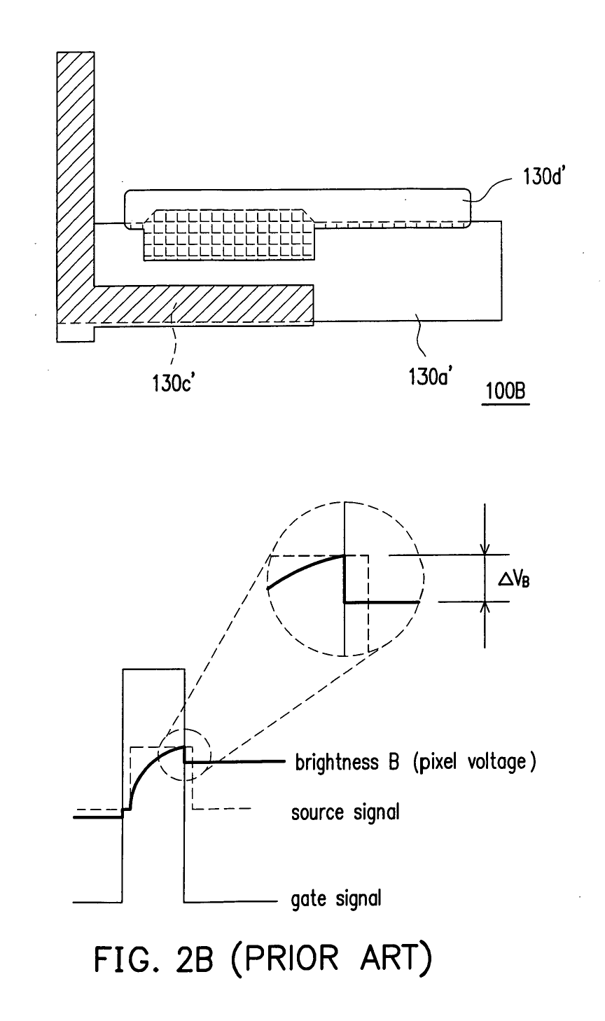

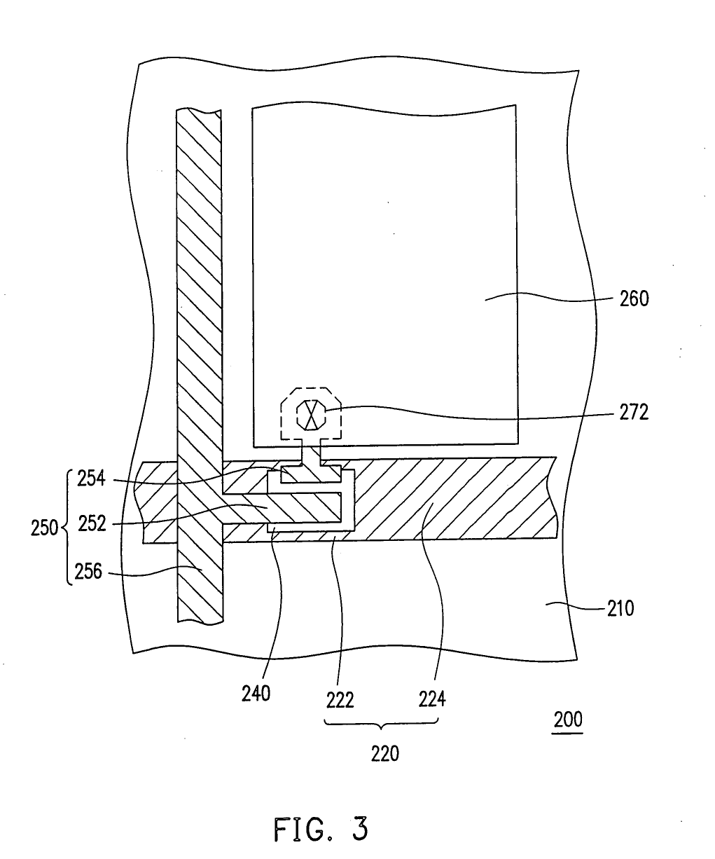

FIG. 3 is a schematic diagram of the pixel structure in an embodiment of the present invention. FIG. 4 is a schematic detailed view of the pixel structure in FIG. 3. FIG. 4A is a schematic section view along line A-A′ in FIG. 4. Referring to FIG. 3, FIG. 4 and FIG. 4A, the pixel structure 200 includes the substrate 210, the first metal layer 220, the first dielectric layer 230, the semiconductor layer 240, the second metal layer 250 and the pixel electrode 260. The first metal layer 220 is disposed on the substrate 210, and the first metal layer 220 includes a gate 222 and a scan line 224 which is electrically connected to the gate 222. The first dielectric layer 230 is disposed on the substrate 210 for covering the first metal layer 220. The semiconductor layer 240 is disposed on the first dielectric layer 230 over the gate 222. The second metal layer 250 includes a source 252, a drain 254 and a data line 256. The source 252 and the drain 254 are partially disposed on the semiconductor layer 240. The data line 256 and the source 252 are electrically connected. The pixel electrode 260 and the drain 254 are electrically connected. Wherein, the drain 254 has a main body 254a which is partially on the semiconductor layer 240 and an extension portion 254b which is projected out of the scan line 224 from the main body 254a. The main body 254a has a first length L1, and the interface of the extension portion 254b and the scan line 224 is a second length L2. And the first length L1/the second length L2 is a predetermined ratio.

Still referring to FIG. 3, FIG. 4 and FIG. 4A, in an embodiment of the present invention, the gate 222 can be the scan line 224 itself. In other words, the scan line 224 has a specific width, and the components such as the semiconductor layer 240, the source 252 and the drain 254 and etc. are fabricated on the scan line 224 to form a TFT. However, the present invention is not limited to the above method. A gate pattern (not shown) can be fabricated separately, so that the gate pattern and the scan line 224 are electrically connected, and the TFT is formed on the gate pattern. And the material of the gate 222 and the scan line 224 for example is aluminum metal or other appropriate conductive material.

In addition, in an embodiment, the semiconductor layer 240 may include a channel layer 240a and a ohmic contact layer 240b. The channel layer 240a is disposed on the first dielectric layer 203 over the gate 222. The ohmic contact layer 240b is disposed on the channel layer 240a. And the material of the channel layer 240a, for example, is amorphous silicon, and the material of the ohmic contact layer 240b, for example, is doped amorphous silicon.

The material of the source 252, the drain 254 and the data line 256 in the second metal layer 250 may be aluminum metal or other appropriate conductive material. Moreover, the above pixel structure 200 may further include a second dielectric layer 270 disposed on the substrate 210 and covering the second metal layer 250. In addition, the second dielectric layer 270 has an opening 272 exposing a portion of the drain 254, so that the pixel electrode 260 on the second dielectric layer 270 is electrically connected to the drain 254 through the opening 272.

Please referring to FIG. 4, note that the drain 254 includes the main body 254a and the extension portion 254b. The main body 254a has the first length L1 (i.e. the channel length), and the interface of the extension portion 254b and the scan line 224 is the second length L2. Specifically, the first length L1/the second length L2 is a predetermined ratio. In an embodiment, the above predetermined ratio is (∈_{SE}t_{GI}+∈_{GI}t_{SE})/(∈_{GI}t_{SE}), wherein ∈_{SE} is the dielectric constant of the semiconductor layer 240, t_{GI} is the thickness of the first dielectric layer 230, ∈_{GI} is the dielectric constant of the first dielectric layer 230, t_{SE} is the thickness of the semiconductor layer 240. In an preferred embodiment, the predetermined ratio (L1/L2) is 1/4. In this way, even though the exposure shifting occurs, the Cgd of the pixel structure 200 does not change.

The principle of making the predetermined ratio of the first length L1/the second length L2 (L1/L2) equal to (∈_{SE}t_{GI}+∈_{GI}t_{SE})/(∈_{GI}t_{SE}) so that the Cgd is unchanged will be described below.

Referring FIG. 4 and FIG. 4A, since the drain 254 partially covers the semiconductor layer 240, a parasite capacitance effect with the C_{SE+GI} and the C_{GI} is developed, and the sum of the effect of the two capacitances is Cgd.

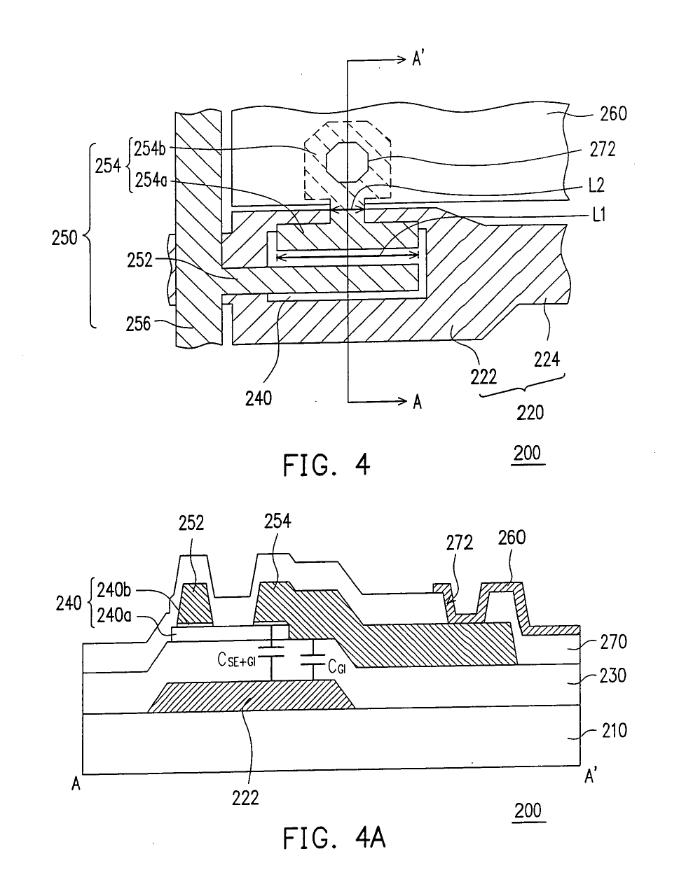

FIG. 5 is a schematic diagram when the exposure shifting occurs on the pixel structure in FIG. 4. Referring to FIG. 5, when the exposure shifting occurs, the second metal layer 250 may shift upwards relatively, i.e. the drain 254 may shift upward relatively. At this time, as shown in FIG. 5, the ΔC_{SE+GI} between the drain 254 and gate 222 will be decreased and the ΔC_{GI} will be increased. However, to keep the effect sum Cgd of the two capacitance unchanged, ΔC_{GI}=ΔC_{SE+GI} is required.

When ΔC_{GI}=ΔC_{SE+GI}, the follow relation formula can be derived:

$$Δ {C}_{GI} = Δ {C}_{SE + GI} \\ ∵ \frac{1}{Δ {C}_{SE + GI}} = \frac{1}{Δ {C}_{SE}} + \frac{1}{Δ {C}_{GI}} ⇒ Δ {C}_{SE + GI} = \frac{Δ {C}_{SE} \times Δ {C}_{GI}}{Δ {C}_{SE} + Δ {C}_{GI}} \\ ∴ {ɛ}_{GI} \frac{Δ {A}_{GI}}{{t}_{GI}} = \frac{{ɛ}_{SE} \frac{Δ {A}_{SE + GI}}{{t}_{SE}} \times {ɛ}_{GI} \frac{Δ {A}_{SE + GI}}{{t}_{GI}}}{{ɛ}_{SE} \frac{Δ {A}_{SE + GI}}{{t}_{SE}} + {ɛ}_{GI} \frac{Δ {A}_{SE + GI}}{{t}_{GI}}}$$

$${ɛ}_{GI} \frac{Δ {A}_{GI}}{{t}_{GI}} = Δ {A}_{SE + GI} \frac{{ɛ}_{SE} {ɛ}_{GI}}{{ɛ}_{SE} {t}_{GI} + {ɛ}_{GI} {t}_{SE}} ⇒ {ɛ}_{GI} \frac{( L 1 - L 2 ) \times d}{{t}_{GI}} = L 1 \times d \frac{{ɛ}_{SE} {ɛ}_{GI}}{{ɛ}_{SE} {t}_{GI} + {ɛ}_{GI} {t}_{SE}} L 1 \text{:} L 2 = {ɛ}_{SE} {t}_{GI} + {ɛ}_{GI} {t}_{SE} \text{:} {ɛ}_{GI} {t}_{SE} \\$$

Based on the above description, it can be seen that when the predetermined ratio (L1/L2) is (∈_{SE}t_{GI}+∈_{G1}t_{SE})/(∈_{GI}t_{SE}), the decreased quantity of ΔC_{SE+GI} may equal to the increased quantity of ΔC_{GI}, i.e. the Cgd does not change. Wherein the ΔA_{GI} is a changed area of the first dielectric layer 230 sandwiched between the drain 254 and the gate 222. The ΔA_{SE+GI} is a changed area of the semiconductor layer 240 and the first dielectric layer 230 sandwiched between the drain 254 and the gate 222. The ∈_{SE} is the dielectric constant of the semiconductor 240. The t_{GI} is the thickness of the first dielectric layer 230. The ∈_{GI} is the dielectric constant of the first dielectric layer 230. The t_{SE} is the thickness of the semiconductor 240. The d is the exposure shifting length of the gate 222 and the drain 254.

In addition, it can be seen according to the formula (I) again that when Cgd is fixed, ΔVp is also unchanged. Therefore, even though the exposure shifting phenomenon occurs during the fabricating process of the pixel structure 200, Cgd of the pixel structure 200 does not change. Therefore, the pixel voltage of the pixel structures 200 also does not change, so that the pixel structures 200 have the same brightness.

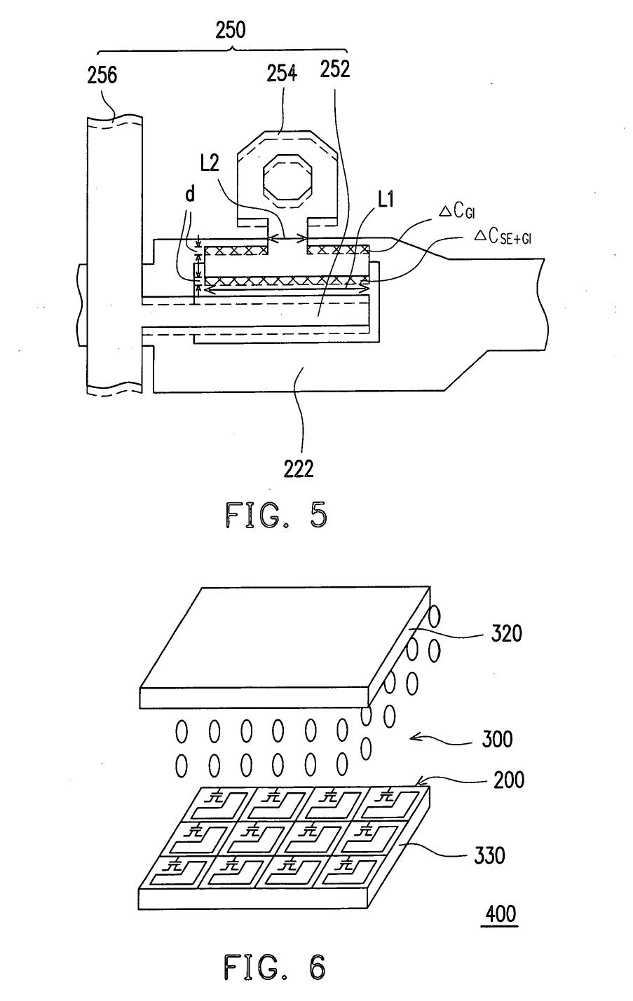

FIG. 6 is a schematic diagram of a LCD panel of an embodiment of the present invention. Referring to FIG. 6, the LCD panel 400 includes a TFT array substrate 300, a color filter substrate 320 and a liquid crystal layer 330 which is between the color filter substrate 320 and the TFT array substrate 300.

Wherein the TFT array substrate 300, for example, has a plurality of pixel structures 200 as shown in FIG. 4. The same and the similar components thereof will not be described here again. Note that the drain has the main body 254a which is partially disposed on the semiconductor layer 240 and the extension portion 254b projected out of the scan line 224 from the main body 254a in the pixel structure 200. The main body 254a has the first length L1, and the interface of the extension portion 254b and the scan line 224 is the second length L2, and the first length L1/the second length L2 is a predetermined ratio. In an embodiment, the predetermined ratio is (∈_{SE}t_{GI}+∈_{GI}t_{SE})/(∈_{GI}t_{SE}), wherein ∈_{SE} is the dielectric constant of the semiconductor layer 240, t_{GI} is the thickness of the first dielectric layer 230, ∈_{GI} is the dielectric constant of the first dielectric layer 230, t_{SE} is the thickness of the semiconductor layer 240. In an preferred embodiment, the predetermined ratio (L1/L2) is 1/4. In this way, even though the exposure shifting occurs during the fabricating process of the pixel structure 200, Cgd of the pixel structure 200 does not change. Therefore, all of the pixel structures 200 on the TFT array substrate 300 have a specific display brightness, thus the display quality of the LCD panel 400 is improved.

To sum up, the pixel structure and the LCD panel of the present invention has at least the following advantages:

(1) Even though the exposure shifting phenomenon occurs during the fabricating process of the pixel structure, Cgd of the pixel structure does not change. Therefore, the present invention can avoid uneven display due to the exposure shifting, and as a result, all the pixel structures have the same brightness.

(2) The LCD panel using such pixel structure has the same brightness, and the display quality of the LCD panel can be improved, and the manufacturing cost can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure, comprising:
a substrate;
a first metal layer, disposed on the substrate, the first metal layer comprising:
a gate;
a scan line, electrically connected to the gate;
a first dielectric layer, disposed on the substrate, and covering the first metal layer;
a semiconductor layer, disposed on the first dielectric layer over the gate;
a second metal layer, comprising:
a source and a drain, partially disposed on the semiconductor layer;
a data line, electrically connected to the source; and
a pixel electrode, electrically connected to the drain;
wherein the drain has a main body partially disposed on the semiconductor layer, and an extension portion projected out of the scan line from the main body, wherein the main body has a first length, and the interface of the extension portion and the scan line is a second length, and the first length/the second length is a predetermined ratio.

2. The pixel structure as claimed in claim 1, wherein the predetermined ratio is (∈_{SE}t_{GI}+∈_{GI}t_{SE})/(∈_{GI}t_{SE}), ε_{SE} is the dielectric constant of the semiconductor layer, t_{G1} is the thickness of the first dielectric layer, ∈_{GI} is the dielectric constant of the first dielectric layer, and t_{SE} is the thickness of the semiconductor layer.

3. The pixel structure as claimed in claim 1, wherein the predetermined ratio is 1/4.

4. The pixel structure as claimed in claim 1, wherein the gate is the scan line.

5. The pixel structure as claimed in claim 1, wherein the semiconductor layer comprises a channel layer and an ohmic contact layer, the channel layer being on the first dielectric layer over the gate, the ohmic contact layer being on the channel layer.

6. The pixel structure as claimed in claim 1, further comprising a second dielectric layer disposed on the substrate and covering the second metal layer.

7. The pixel structure as claimed in claim 6, wherein the second dielectric layer has an opening exposing a portion of the drain, so that the pixel electrode on the second dielectric layer is electrically connected to the drain through the opening.

8. A LCD panel, comprising:
a TFT array substrate, comprising a plurality of pixel structures, wherein each pixel structure comprises:
a substrate;
a first metal layer, disposed on the substrate, the first metal layer comprising:
a gate;
a scan line, electrically connected to the gate;
a first dielectric layer, disposed on the substrate and covering the first metal layer;
a semiconductor layer, disposed on the first dielectric layer over the gate;
a second metal layer, comprising:
a source and a drain, partially disposed on the semiconductor layer;
a data line, electrically connected to the source; and
a pixel electrode, electrically connected to the drain;
a color filter substrate, disposed on the opposite side of the TFT array substrate; and
a liquid crystal layer, disposed between the TFT array substrate and the color filter substrate;
wherein the drain has a main body partially disposed on the semiconductor layer, and an extension portion projected out of the scan line from the main body, wherein the main body has a first length, and the interface of the extension portion and the scan line is a second length, and the first length/the second length is a predetermined ratio.

9. The LCD panel as claimed in claim 8, wherein the predetermined ratio is (∈_{SE}t_{GI}+∈_{GI}t_{SE})/(∈_{GI}t_{SE}), ∈_{SE} is the dielectric constant of the semiconductor layer, t_{GI} is the thickness of the first dielectric layer, ∈_{GI} is the dielectric constant of the first dielectric layer, and t_{SE} is the thickness of the semiconductor layer.

10. The LCD panel as claimed in claim 8, wherein the predetermined ratio is 1/4.

11. The LCD panel as claimed in claim 8, wherein the gate is the scan line.

12. The LCD panel as claimed in claim 8, wherein the semiconductor layer comprises a channel layer and an ohmic contact layer, the channel layer being on the first dielectric layer over the gate, the ohmic contact layer being on the channel layer.

13. The LCD panel as claimed in claim 8, further comprising a second dielectric layer disposed on the substrate and covering the second metal layer

14. The LCD panel as claimed in claim 13, wherein the second dielectric layer has an opening exposing a portion of the drain, so that the pixel electrode on the second dielectric layer is electrically connected to the drain through the opening.
